(19) United States
(12) Patent Application Publication
(10) Pub. No.: US 2025/0341443 A1
(43) Pub. Date: Nov. 6, 2025

(54) Measuring Equipment Vibration for Maintenance Activities

(71) Applicant: Saudi Arabian Oil Company, Dhahran (SA)

(72) Inventors: Siddharth Mishra, Dhahran (SA); Sahejad Patel, Thuwal (SA); Hassane Trigui, Thuwal (SA)

(21) Appl. No.: 18/653,505

(22) Filed: May 2, 2024

(51) Int. Cl. G01M 7/02; B25J 5/00; B25J 19/02

(52) U.S. Cl. CPC G01M 7/025; B25J 5/007; B25J 19/02

(57) ABSTRACT

Methods, systems, and apparatus operate to determine a health profile of a mechanical device including using a mobile robotic system to determine a location of a mechanical device. The mobile robotic system determines a location of a component of the mechanical device and measures a vibration parameter at the location of the component of the mechanical device. If the vibration measurement is outside a predetermined range, the system alerts personnel.

### TECHNICAL FIELD

The present disclosure relates to monitoring machinery operations.

### BACKGROUND

In an oil and gas production operation, machinery includes various rotating components including pumps, fans, compressors, turbines, etc. In addition, machinery includes various static components including piping, valves, structural platforms, etc. The dynamic nature of machinery involved in oil and gas production leads to components suffering from effects of vibration. Accurately evaluating the vibration of machinery components related to oil and gas production is important for identifying components that require maintenance.

### SUMMARY

This specification describes techniques that can be used for identifying components of a mechanical device that require maintenance by evaluating vibration of the components. Oil and gas production facilities, as well as warehouses, plants, and other facilities often contain multiple mechanical devices that include rotating and static components. Misalignment of rotating components, and other mechanical deviations from normal operation, can result in vibrations of both rotating and static components outside of a normal operating range. For example, a misaligned turbine can result in an external housing that experiences a vibrational state outside of a normal operating range. A frequent and repeatable evaluation of vibrations in relation to components of mechanical devices in production facilities is an important part of monitoring the health of the mechanical devices to determine if pre-emptive maintenance is required to maintain a productive facility with minimal downtime.

Typical evaluation of vibrations of mechanical devices includes manual vibration measurements across multiple components and multiple devices in a facility by technicians. The system described in this specification includes a mobile robotic system that can traverse a facility (e.g., an oil and gas production facility) to evaluate vibrations on multiple components of multiple devices and provide repeatable data analysis on a pre-determined schedule. Assisted by machine learning models that are trained to identify particular mechanical devices and associated components, and to analyze vibration data to determine if maintenance is required, the mobile robotic system can be fully or semi-autonomous to automate the process of recording and analyzing vibration data.

Implementations of the systems and methods of this disclosure can provide various technical benefits. A mobile robotic system can provide frequent and accurate evaluations of vibrations of components of mechanical devices within a warehouse, plant, oil and gas production facility, etc. The mobile robotic system executes operations pertaining to multiple machine learning models, including a model to identify the location of a particular mechanical device, a model to identify the position of particular component of the particular mechanical device, and a model to analyze the associated vibration measurement to determine if a maintenance activity is required. By replacing a manual vibration analysis by a technician, the mobile robotic system can ensure vibration analysis is performed on a repeatable schedule using repeatable measurement protocols. More accurate longitudinal analysis of vibration data is achieved by standardizing the measurement technique and frequency. By integrating an alerting system to the mobile robotic system, automated maintenance requests and malfunction alerts can be generated to minimize downtime of devices subject to vibrational disturbances.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic diagram that illustrates an example mechanical device and an example vibration measurement system.

FIG. 2 is a schematic diagram that illustrates an example vibration measurement system.

FIG. 3 is a schematic diagram that illustrates an example mobile robotic system.

FIG. 4 is a schematic diagram that illustrates an example processing system that implements machine learning models.

FIG. 5 is a flow diagram of an example process for measuring the vibration of a component of a mechanical device.

FIG. 6 is a schematic diagram of an example mechanical device with static and rotating components.

FIG. 7 is a schematic illustrating field operations to produce hydrocarbons.

FIG. 8 is a diagram of an example computing system.

Like reference numbers and designations in the various drawings indicate like elements.

### DETAILED DESCRIPTION

This specification describes techniques that can be used for identifying components of a mechanical device that require maintenance by evaluating vibration of the components. In some operations, technicians travel to each mechanical device in a particular warehouse, plant, or oil and gas production facility to record vibration measurements. The technician is specially trained to identify particular components of mechanical devices to perform vibration measurements, how to perform vibration measurements, and how to analyze the results of each measurement to determine if a particular component required maintenance.

The techniques described in this specification offer an alternative to manual vibration measurements performed by technicians. A single mobile robotic system provides vibration measurement and analysis using an automated process ensuring that a monitoring schedule with frequent analysis is followed.

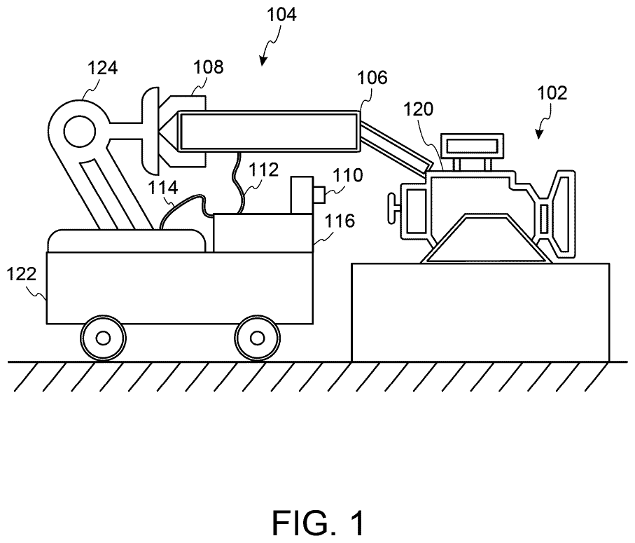

FIG. 1 is a schematic diagram that illustrates an example mechanical device 102 and an example mobile robotic system 104. The mobile robotic system 104 is equipped with a vibration sensor 106 to measure vibrations of a component 120 of the mechanical device 102.

The mobile robotic system 104 includes a wheeled platform 122 and an extendable element 124 (e.g., a mechanical arm). The extendable element 124 is equipped with a gripper 108 that can hold the vibration sensor 106. A processor 116 includes a motion controller that sends commands to the wheeled platform 122 and the extendable element 124. A camera 110 is positioned on the mobile robotic system 104 and communicatively coupled to the processor 116. Images from the camera 110 are processed by one or more machine learning models to identify the mechanical device 102, identify the component 120 of the mechanical device 102, and analyze the vibration data collected by the vibration sensor 106 which is communicatively coupled to the processor 116 through cable 112. In some implementations, the vibration sensor 106 is coupled wirelessly to the processor 116. The extendable element 124 is communicatively coupled to the processor 116 through cable 114. In some implementations, the extendable element 124 is coupled wirelessly to the processor 116.

In some implementations, the mobile robotic system 104 navigates through an oil and gas production facility, plant, or warehouse to collect vibration measurements on components of mechanical devices. The example mechanical device 102 is a pump with rotating elements that can cause unwanted vibrations due to misaligned moving parts. The mobile robotic system 104 accesses computer vision machine learning models to identify mechanical devices and to identify components of mechanical devices. In addition, the mobile robotic system 104 accesses data analysis machine learning models to determine if a measured vibration data collected with respect to a particular component of a mechanical device is indicative of a device that needs preemptive maintenance.

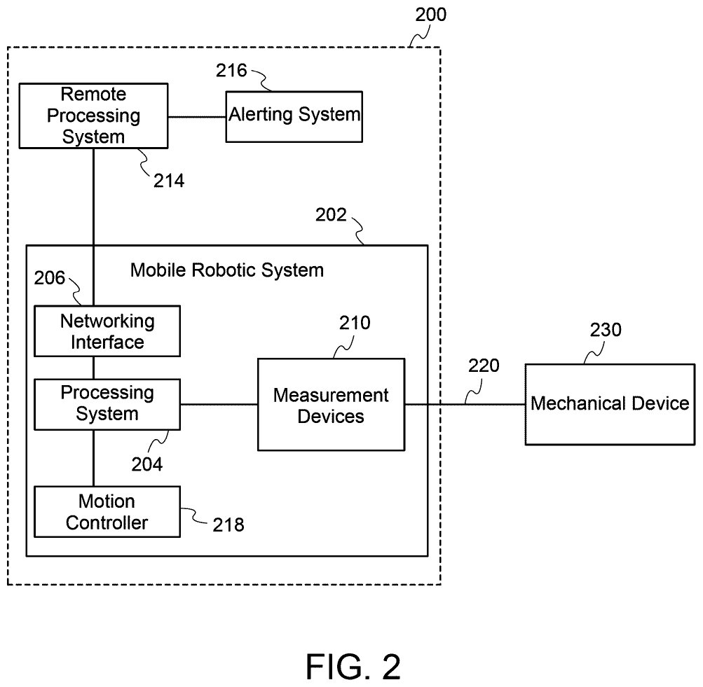

FIG. 2 is a schematic diagram that illustrates an example vibration measurement system 200. The system 200 includes a mobile robotic system 202, a remote processing system 214, and an alerting system 216. The mobile robotic system 202 includes measurement devices 210, a local processing system 204, and a motion controller 218. In some implementations, the motion controller is implemented by a processor included in the processing system 204.

In some cases, a mechanical device 230 is one of multiple mechanical devices present in a warehouse, plant, or oil and gas production facility. The mechanical device 230 is an object under test in relation to the example vibration measurement system 200. In other words, the devices, processors, and methods executed by the system 200 are for evaluating vibrations in relation to one or more components of the mechanical device 230.

In some cases, a warehouse, plant, or oil and gas production facility includes multiple mechanical devices. For example, a particular oil and gas production facility can include mechanical devices with rotating components like pumps, fans, compressors, turbines, etc. As another example, the particular oil and gas production facility can include non-rotating components like piping, valves, structural platforms, etc. In general, components experience vibrations due to a variety of sources, both external and internal to the device itself. For example, a misaligned component of a turbine can induce vibrations on components and lead to degradation of one or more components of the turbine. The system 200 measures and analyzes vibrations on one or more components of the mechanical device 230 to determine if maintenance of the mechanical device 230 is required.

The local processing system 204 of the mobile robotic system 202 is communicatively coupled with the measurement devices 210 that interact with the components of the mechanical device 230 (e.g., pumps, axles, valves, etc.). Each measurement device of the measurement devices 210 interacts with the mechanical device either through touch (e.g., vibration sensor, pressure sensor, etc.), vision (e.g., camera), and/or audio (e.g., acoustic sensors). Data collected by the measurement devices 210 in relation to the mechanical device 230 is received by the processing system 204.

The processing system 206 interacts with the motion controller 218. The motion controller receives inputs from the processing system 204 and generates motion commands to one or more movable elements of the mobile robotic system 202. For example, the inputs from the processing system 204 can be an output from one or more machine learning models that are indicative of a position of a particular mechanical device or a particular component of a mechanical device. The motion controller 218 can provide electrical signals to one or more motors or motion devices of the mobile robotic system 202 to move the system 202 closer to a particular device or component. For example, the motion controller 218 can activate wheels of the mobile robotic system 202 to move next to a particular mechanical device located in an oil and gas production facility. As another example, the motion controller 218 can activate an extendable arm to move a vibration sensor in contact with a vibrating component of a particular mechanical device. As another example, the motion controller 218 can receive data from a pressure sensor included in the measurement devices 210 that is indicative of the vibration sensor providing too much pressure to the vibrating component and to retract the extendable arm to reduce the pressure. As another example, in the case of an aerial mobile robotic system (e.g., a drone), the motion controller 218 can provide electrical signals to one or more rotating blades to navigate the mobile robotic system 202 to a position near a particular component of a mechanical device to obtain a vibration measurement.

In some implementations, the mobile robotic system 202 is a mobile wheeled robotic system. In some other implementations, the mobile robotic system 202 is an aerial robotic system. In some other implementations, the mobile robotic system 202 is a legged robotic system. In some other implementations, the mobile robotic system 202 is any robotic system that can navigate by any means between multiple mechanical devices in a particular region, e.g., within a warehouse, plant, or oil and gas production facility.

The mobile robotic system 202 is communicatively coupled through a networking interface 206 to a remote processing system 214. In some cases, the remote processor 214 can execute the same operations of the local processing system 204 instead of the local processing system 204. The remote processing system 214 can include multiple processors and/or databases and can execute instructions for analyzing vibration measurements collected by the measurement devices 210 and analyzed by the processing system 204. The remote processing system 214 can execute one or more machine learning models to analyze the vibration measurements. In addition, the remote processing system 214 can execute instructions corresponding to an alerting system 216 that can perform operations according to the outputs of the remote processing system 214 and the local processing system 204. In some cases, the alerting system 216 can initiate maintenance protocols, alert relevant personnel, or perform mitigating actions to avoid damage to a mechanical device or component.

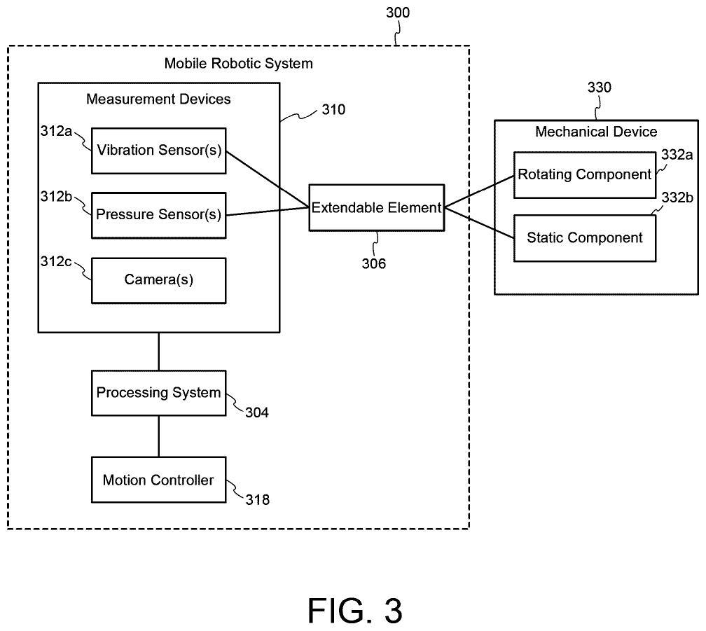

FIG. 3 is a schematic diagram that illustrates an example mobile robotic system 300. The mobile robotic system 300 includes measurement devices 310, a processing system 304, and a motion controller 318. The motion controller 318 provides commands to the mobile robotic system 300 to position the system 300 in a proximity of a mechanical device 330. The mechanical device 330 can be one of many mechanical devices located within a warehouse, plant, oil and gas production facility, etc.

The measurement devices 310 include a vibration sensor 312a and a pressure sensor(s) 312b. The sensors are coupled to an extendable element 306 (e.g., an extendable robotic arm) of the mobile robotic system 300. The motion controller 318 provides commands to position the extendable element 306 on or near a particular component of the mechanical device 330. The vibration sensor 312a is placed on or near the particular component by the extendable element 306 to measure vibrations of the component. The pressure sensor(s) 312b are coupled to the extendable element 306 to provide haptic feedback to the motion controller 318 to indicate if the extendable element 306 should be protracted or retracted when the vibration sensor 312a is in contact with the particular component to provide the correct amount of pressure during the measurement process.

In some implementations, the extendable element 306 includes a gripper, in which the gripper can hold a variety of vibration sensors. In some other implementations, the extendable element 306 is specially designed to couple with a particular vibration sensor. In some implementations, the extendable element 306 can grip and/or access multiple vibrations sensors simultaneously and choose an appropriate vibration sensor depending on the particular mechanical device or component in its proximity.

The measurement devices 310 include one or more cameras 312c that can record images and/or video data of an area surrounding the mechanical device 330, components of the mechanical device 330, and the entire region of the particular warehouse, plant, oil and gas production facility, etc. The cameras 312c can provide visual information pertaining to the surroundings of the mobile robotic system 300.

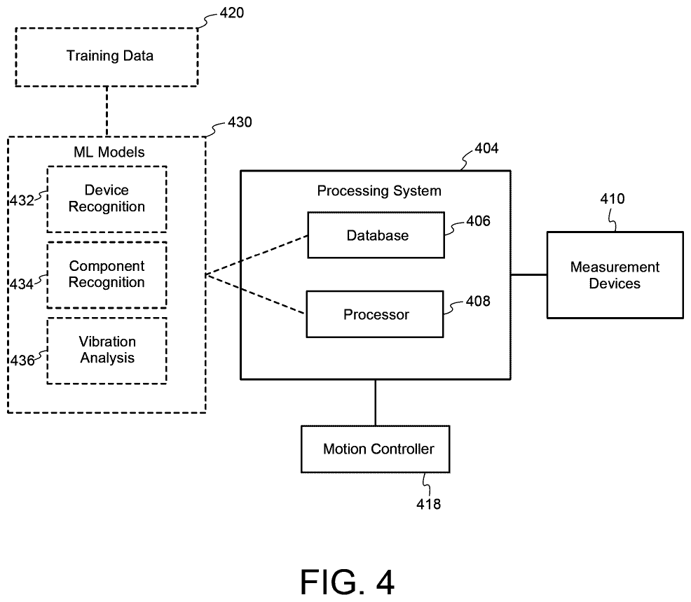

FIG. 4 is a schematic diagram that illustrates an example processing system 404 that implements machine learning models 430. The example processing system 404 is a component of a mobile robotic system (e.g., the mobile robotic system 300), in which the processing system 404 is communicatively coupled to a motion controller 418 and measurement devices 410. The processing system 404 can store data and execute instructions pertaining to the multiple machine learning models 430 that are trained using training data 420.

The machine learning models 430 include a first machine learning model (e.g., a device recognition model 432) that is trained to identify particular mechanical devices (e.g., the mechanical device 330). The device recognition model 432 can differentiate between multiple mechanical devices that are located in a warehouse, plant, oil and gas production facility, etc. The training data 420 includes labeled images of mechanical devices. In some cases, the training data 420 includes labeled images of a mechanical devices taken at multiple angles, vantage points, and configurations.

In some implementations, the device recognition model 432 is aided by a map of the facility that includes the location and types of all mechanical devices in the facility. The processing system 404 loads the map of the facility to the processing system 404 to locate each mechanical device. The motion controller 418 provides commands (e.g., electrical signals to one or more motion devices like wheels, legs, rotors, etc.) to position the mobile robotic system in a vicinity of a target mechanical device, based on the location of the target mechanical device as described by the map of the facility. In some cases, the device recognition model 432 can confirm the existence and location of the device by analyze image data of the region near the target mechanical device.

In some other implementations, the device recognition model 432 is aided by a simultaneous localization and mapping (SLAM) process. The SLAM process includes recording a sequence of movements directed by the processing system 404 and enabled by the motion controller 418 to explore the facility and generate a map of the facility. In this implementation, the map is not loaded directly to the processing system 404. Instead, the mobile robotic system learns the map of the facility over time by exploring the boundaries of the facility. Once the map of the facility is learned, the system can load the learned map in a similar way to the pre-determined map discussed above. In some cases, the map acquired by the SLAM process is further processed to label particular devices and/or equipment located in the facility.

In some implementations, the mobile robotic system navigates to the target mechanical device autonomously. In some other implementations, the mobile robotic system navigates to the target mechanical device semi-autonomously, where an operator selects a location of the target mechanical device using a graphical user interface and aids the mobile robotic system as it navigates to the target device. In some other implementations, the operator full controls the motion of the mobile robotic system by providing navigation commands to the system to navigate it to the target mechanical device.

The machine learning models 430 include a second machine learning model (e.g., a component recognition model 434) that is trained to identify specific components (e.g., rotating component 332a and static component 332b) of particular mechanical devices in the facility. In some implementations, the training data 420 includes labeled images of device components from multiple angles, vantage points, and configurations. In some implementations, the component recognition model 434 is trained using an unsupervised technique in which the model 434 can identify and locate components to evaluate without the components present in a training data set.

The machine learning models 430 include a third machine learning model (e.g., a vibration analysis model 436) that is trained to analyze the vibration data collected by the measurement devices 410. A particular vibration analysis is specific to each type of mechanical device and a location of each device. In some cases, a particular vibration analysis model 436 is trained for each type of mechanical device, or each type of component for each type of mechanical device. Elements of the training data 420 pertaining to the vibration analysis model 436 can include data obtained manually and analyzed by trained technicians, vibration data obtained and analyzed by existing robotic systems, and/or vibration data obtained and analyzed by other systems including internet of things devices attached to specific mechanical devices.

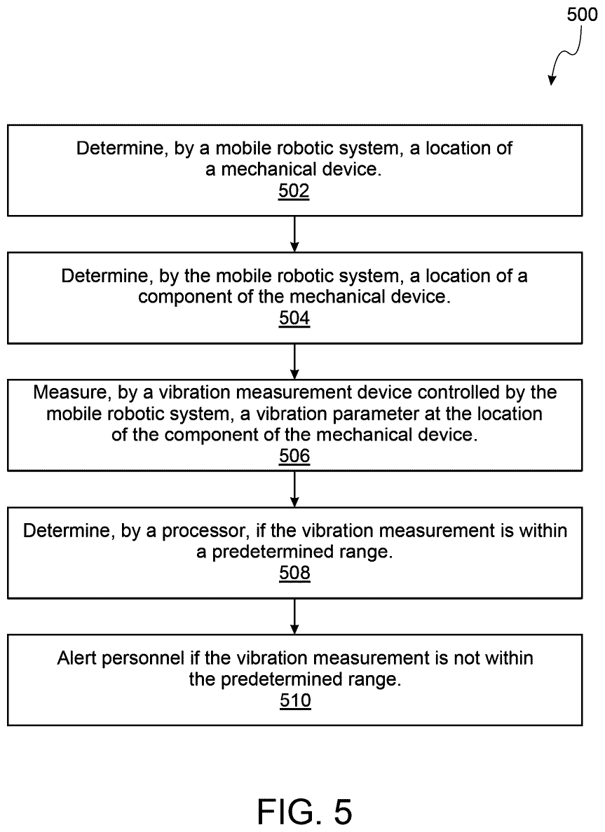

FIG. 5 is a flow diagram of an example process 500 for measuring the vibration of a component of a mechanical device. For clarity of presentation, the description that follows generally describes process 500 in the context of the other figures in this description. In some implementations, various steps of process 500 can be performed in parallel, in combination, in loops, or in any order.

The system determines (502), by a mobile robotic system, a location of a mechanical device. In some cases, the mechanical device is one or many devices in an oil and gas production facility, plant, warehouse, etc. In some cases, the mobile robotic system loads a map of the facility to determine a location of a particular mechanical device. The map of the facility can be loaded directly or can be determined iteratively using one or more machine learning techniques. In some implementations, a user selects a particular mechanical device from a list of mechanical devices on a graphical user interface. The mobile robotic system subsequently navigates to the particular mechanical device to perform one or more vibration measurements.

The system determines (504), by the mobile robotic system, a location of a component of the mechanical device. In general, the mechanical device includes multiple static and rotating components. In some cases, misaligned or defective rotating or moving components can cause vibrations outside of a predetermined threshold that can cause damage to the mechanical device. The system can determine the location of a particular component of a mechanical device with a machine learning model, in which the machine learning model is trained with multiple labeled images of components of mechanical devices. In some implementations, the system is trained to identify multiple components that correspond to various mechanical devices in a particular facility.

The system measures (506), by a vibration measurement device controlled by the mobile robotic system, a vibration parameter at the location of the component of the mechanical device. After the location of the component is determined, the system can bring the vibration measurement device near, or in contact with, the component. The mobile robotic system can be equipped with an agile extendable element with a gripper that can hold the measurement device. The extendable element can maneuver around objects to bring the vibration measurement device suitably close to the component. In some implementations, the vibration measurement device is in contact with the component. In some other implementations, the vibration measurement device is in the vicinity of the component.

The system determines (508), by a processor, if the vibration measurement is within a predetermined range. In some cases, the processor is local to the mobile robotic system. In some other implementations, the processor is remote in relation to the mobile robotic system and is communicatively coupled to a local processor with a networking interface. The process executes operations associated with a machine learning model that is trained to identify signatures of a vibration signal that indicates a parameter to be outside of the predetermined range. In some cases, a component that is subject to vibrations outside of the predetermined range can receive preemptive servicing or maintenance to avoid unnecessary downtime due to damage or improper operation.

The system alerts (510) personnel if the vibration measurement is not within the predetermined range. In some implementations, the system initiates a work order for maintenance on a particular mechanical device or component of a mechanical device. In some implementations, the system displays alerts and/or pertinent information regarding the status of a component on a graphical user interface.

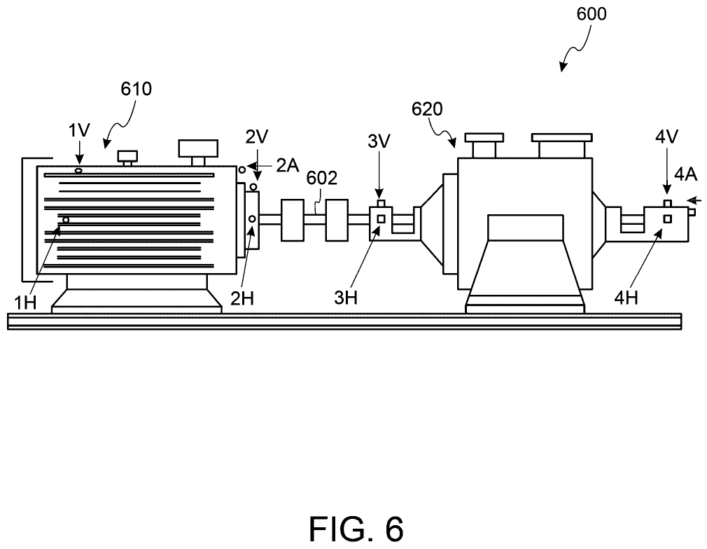

FIG. 6 is a schematic diagram of an example mechanical device 600 with static and rotating components. The example mechanical device 600 includes an electric motor 610 that drives a centrifugal pump 620. The electric motor 610 and the centrifugal pump 620 include bearing housings in which the housings can experience vibrations due to the motion of a drive shaft 602. In some cases, the drive shaft 602 can become misaligned and damage one or more components of the mechanical device 600. An analysis of vibration measurements performed at multiple positions on the mechanical device 600 can provide an indication of the alignment of the drive shaft 602 or of the health of one or more other components of the mechanical device 602.

In some implementations, a machine learning model (e.g., the component recognition model 434) can identify positions on the mechanical device 602 to obtain vibration measurements. In some cases, a camera on a mobile robotic system (e.g., the camera(s) 412c of the mobile robotic system 400) can record image data in the vicinity of the mechanical device 600 to determine the positions of multiple vibration measurement targets. In some cases, a vibration sensor (e.g., the vibration sensor 312a) can measure a vibrational state along multiple axes. For example, the vibration sensor can evaluate the vibration of a component of the mechanical device 600 along a direction parallel to a main axis of the drive shaft 602 (e.g., indicated at positions 2A and 4A), along a direction perpendicular to the main axis of the drive shaft 602 and perpendicular to the ground (e.g., indicated at positions 1H, 2H, 3H, and 4H), and along a direction perpendicular to the main axis of the drive shaft 602 and parallel to the ground (e.g., indicated at positions 1V, 2V, 3V, and 4V).

In some implementations, the mobile robotic system can include two or more extendable elements (e.g., the extendable element 306 of the mobile robotic system 300) to record vibrational data with two vibration sensors simultaneously. The system can determine a differential vibrational measurement based on the two simultaneous vibration sensors to decouple noise of the system and to amplify a valid vibrational signal.

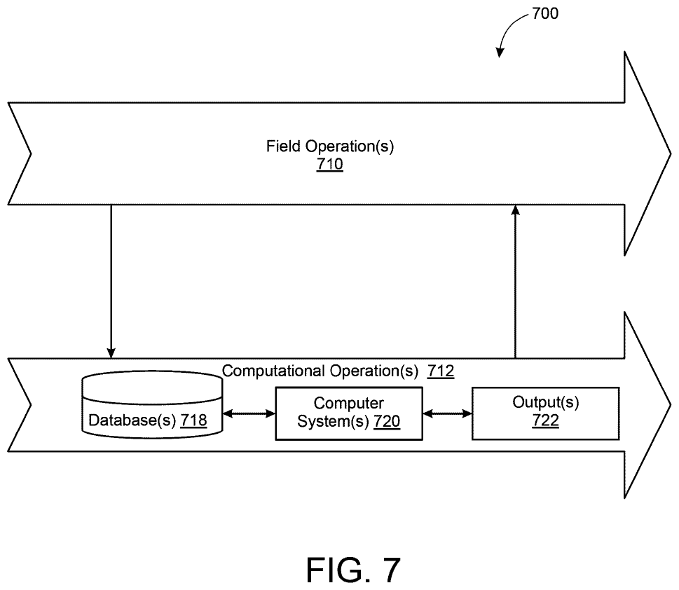

FIG. 7 illustrates hydrocarbon production operations 700 that include both one or more field operations 710 and one or more computational operations 712, which exchange information and control exploration to produce hydrocarbons. In some implementations, outputs of techniques of the present disclosure (e.g., the method 200) can be performed before, during, or in combination with the hydrocarbon production operations 700, specifically, for example, either as field operations 710 or computational operations 712, or both. For example, the process 200 collect data during field operations, processes the data in computational operations, and can determine locations to perform additional field operations.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively, or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 10 s. While the requested data need not be displayed (or initiated for display) instantaneously, it is displayed (or initiated for display) without any intentional delay, accounting for processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are in different countries or other jurisdictions.

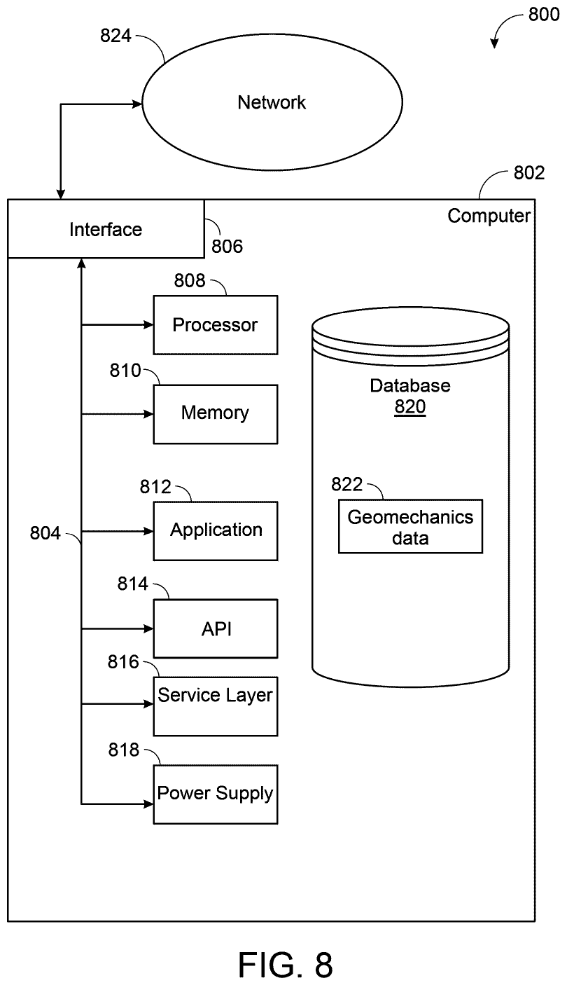

FIG. 8 is a block diagram of an example computer system 800 used to provide computational functionalities associated with described algorithms, methods, functions, processes, flows, and procedures described in the present disclosure, according to some implementations of the present disclosure. The illustrated computer 802 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI).

The computer 802 can serve in a role as a client, a network component, a server, a database, a persistency, or components of a computer system for performing the subject matter described in the present disclosure. The illustrated computer 802 is communicably coupled with a network 824. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 824 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 804. In some implementations, any or all of the components of the computer 802, including hardware or software components, can interface with each other or the interface 806 (or a combination of both), over the system bus 804. Interfaces can use an application programming interface (API) 814, a service layer 816, or a combination of the API 814 and service layer 816. The API 814 can include specifications for routines, data structures, and object classes. The API 814 can be either computer-language independent or dependent. The API 814 can refer to a complete interface, a single function, or a set of APIs.

The service layer 816 can provide software services to the computer 802 and other components (whether illustrated or not) that are communicably coupled to the computer 802. The functionality of the computer 802 can be accessible for all service consumers using this service layer. Software services, such as those provided by the service layer 816, can provide reusable, defined functionalities through a defined interface. For example, the interface can be software written in JAVA, C++, or a language providing data in extensible markup language (XML) format. While illustrated as an integrated component of the computer 802, in alternative implementations, the API 814 or the service layer 816 can be stand-alone components in relation to other components of the computer 802 and other components communicably coupled to the computer 802. Moreover, any or all parts of the API 814 or the service layer 816 can be implemented as child or sub-modules of another software module, enterprise application, or hardware module without departing from the scope of the present disclosure.

The computer 802 includes an interface 806. Although illustrated as a single interface 806 in FIG. 8, two or more interfaces 806 can be used according to implementations of the computer 802 and the described functionality. The interface 806 can be used by the computer 802 for communicating with other systems that are connected to the network 824 (whether illustrated or not) in a distributed environment. Generally, the interface 806 can include, or be implemented using, logic encoded in software or hardware (or a combination of software and hardware) operable to communicate with the network 824. More specifically, the interface 806 can include software supporting one or more communication protocols associated with communications. As such, the network 824 or the interface's hardware can be operable to communicate physical signals within and outside of the illustrated computer 802.

The computer 802 includes a processor 808. Although illustrated as a single processor 808 in FIG. 8, two or more processors 808 can be used according to implementations of the computer 802 and the described functionality. Generally, the processor 808 can execute instructions and can manipulate data to perform the operations of the computer 802, including operations using algorithms, methods, functions, processes, flows, and procedures as described in the present disclosure.

The computer 802 also includes a database 820 that can hold data (such geomechanics data 822) for the computer 802 and other components connected to the network 824 (whether illustrated or not). For example, database 820 can be in-memory or a database storing data consistent with the present disclosure. In some implementations, database 820 can be a combination of two or more different database types (for example, hybrid in-memory and conventional databases) according to implementations of the computer 802 and the described functionality. Although illustrated as a single database 820 in FIG. 8, two or more databases (of the same, different, or combination of types) can be used according to implementations of the computer 802 and the described functionality. While database 820 is illustrated as an internal component of the computer 802, in alternative implementations, database 820 can be external to the computer 802.

The computer 802 also includes a memory 810 that can hold data for the computer 802 or a combination of components connected to the network 824 (whether illustrated or not). Memory 810 can store any data consistent with the present disclosure. In some implementations, memory 810 can be a combination of two or more different types of memory (for example, a combination of semiconductor and magnetic storage) according to implementations of the computer 802 and the described functionality. Although illustrated as a single memory 810 in FIG. 8, two or more memories 810 (of the same, different, or combination of types) can be used according to implementations of the computer 802 and the described functionality. While memory 810 is illustrated as an internal component of the computer 802, in alternative implementations, memory 810 can be external to the computer 802.

The application 812 can be an algorithmic software engine providing functionality according to implementations of the computer 802 and the described functionality. For example, application 812 can serve as one or more components, modules, or applications. Further, although illustrated as a single application 812, the application 812 can be implemented as multiple applications 818 on the computer 802. In addition, although illustrated as internal to the computer 802, in alternative implementations, the application 812 can be external to the computer 802.

The computer 802 can also include a power supply 818. The power supply 818 can include a rechargeable or non-rechargeable battery that can be configured to be either user- or non-user-replaceable. In some implementations, the power supply 818 can include power-conversion and management circuits, including recharging, standby, and power management functionalities. In some implementations, the power-supply 818 can include a power plug to allow the computer 802 to be plugged into a wall socket or a power source to, for example, power the computer 802 or recharge a rechargeable battery.

There can be any number of computers 802 associated with, or external to, a computer system including the computer 802, with each computer 802 communicating over network 824. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Several implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Several embodiments of these systems and methods have been described. Nevertheless, it will be understood that various modifications may be made without departing from the spirit and scope of this disclosure. Accordingly, other embodiments are within the scope of the following claims.

### EXAMPLES

In some implementations, methods of determining a health profile of a mechanical device include (i) determining, by a mobile robotic system, a location of a mechanical device, (ii) determining, by the mobile robotic system, a location of a component of the mechanical device, (iii) measuring, by a vibration measurement device controlled by the mobile robotic system, a vibration parameter at the location of the component of the mechanical device, (iv) determining, by a processor, if the vibration measurement is within a predetermined range, and (v) alerting personnel if the vibration measurement is not within the predetermined range.

In an example implementation combinable with any other implementation, the mobile robotic system navigates autonomously or semi-autonomously.

In an example implementation combinable with any other implementation, the mobile robotic system comprises an extendable element, the extendable element equipped with a gripper for holding the vibration measurement device.

In an example implementation combinable with any other implementation, the extendable element is a robotic arm.

In an example implementation combinable with any other implementation, the mobile robotic system includes one or more cameras.

In an example implementation combinable with any other implementation, the mobile robotic system includes one or more pressure sensors.

In an example implementation combinable with any other implementation, the processor is a local processor, the local processor local to the mobile robotic system.

In an example implementation combinable with any other implementation, the processor is a remote processor, the remote processor remote from the mobile robotic system and communicatively coupled to the mobile robotic system by a networking interface.

In an example implementation combinable with any other implementation, the processor implements a first machine learning model to determine the location of the mechanical device.

In an example implementation combinable with any other implementation, the processor implements a second machine learning model to determine the location of the component of the mechanical device.

In an example implementation combinable with any other implementation, the processor implements a third machine learning model to determine if the vibration measurement is within the predetermined range.

In an example implementation combinable with any other implementation, the mobile robotic system is an airborne mobile robotic system.

In an example implementation combinable with any other implementation, the mobile robotic system determines the location of the mechanical device based at least in part on a map of a facility.

In an example implementation combinable with any other implementation, the method includes generating a work order to maintenance personnel if the vibration measurement is not within the predetermined range.

In some implementations, systems including a mobile robotic system that includes a wheeled platform, an extendable element, in which the extendable element comprises a gripper, the extendable element attached to the wheeled platform, a vibration measurement device secured by the gripper, and a processing system, in which the processing system is attached directly or indirectly to the wheeled platform.

In an example implementation combinable with any other implementation, a remote processing system, in which the remote processing system is remote from the mobile robotic system and communicatively coupled to the mobile robotic system by a networking interface, in which the networking interface is attached directly or indirectly to the wheeled platform.

In an example implementation combinable with any other implementation, the mobile robotic system includes one or more pressure sensors coupled to the extendable element and communicatively coupled to the processing system.

In an example implementation combinable with any other implementation, the mobile robotic system includes a motion controller, the motion controller communicatively coupled to one or more of the processing system, the extendable element, and the wheeled platform.

In an example implementation combinable with any other implementation, the system includes an alerting system, in which the alerting system alerts personnel if a vibration measurement is not within a predetermined range.

What is claimed is:

1. A method of determining a health profile of a mechanical device comprising:
determining, by a mobile robotic system, a location of a mechanical device;
determining, by the mobile robotic system, a location of a component of the mechanical device;
measuring, by a vibration measurement device controlled by the mobile robotic system, a vibration parameter at the location of the component of the mechanical device;
determining, by a processor, if the vibration measurement is within a predetermined range; and
alerting personnel if the vibration measurement is not within the predetermined range.

2. The method of claim 1, wherein the mobile robotic system navigates autonomously or semi-autonomously.

3. The method of claim 1, wherein the mobile robotic system comprises an extendable element, the extendable element equipped with a gripper for holding the vibration measurement device.

4. The method of claim 3, wherein the extendable element is a robotic arm.

5. The method of claim 1, wherein the mobile robotic system comprises one or more cameras.

6. The method of claim 1, wherein the mobile robotic system comprises one or more pressure sensors.

7. The method of claim 1, wherein the processor is a local processor, the local processor local to the mobile robotic system.

8. The method of claim 1, wherein the processor is a remote processor, the remote processor remote from the mobile robotic system and communicatively coupled to the mobile robotic system by a networking interface.

9. The method of claim 8, wherein the processor implements a first machine learning model to determine the location of the mechanical device.

10. The method of claim 9, wherein the processor implements a second machine learning model to determine the location of the component of the mechanical device.

11. The method of claim 1, wherein the processor implements a third machine learning model to determine if the vibration measurement is within the predetermined range.

12. The method of claim 1, wherein the mobile robotic system is an airborne mobile robotic system.

13. The method of claim 1, wherein the mobile robotic system determines the location of the mechanical device based at least in part on a map of a facility.

14. The method of claim 1, further comprising generating a work order to maintenance personnel if the vibration measurement is not within the predetermined range.

15. A system comprising:
a mobile robotic system comprising:
a wheeled platform;
an extendable element, wherein the extendable element comprises a gripper, the extendable element attached to the wheeled platform;
a vibration measurement device secured by the gripper; and
a processing system, wherein the processing system is attached directly or indirectly to the wheeled platform.

16. The system of claim 15, further comprising a remote processing system, wherein the remote processing system is remote from the mobile robotic system and communicatively coupled to the mobile robotic system by a networking interface, wherein the networking interface is attached directly or indirectly to the wheeled platform.

17. The system of claim 15, wherein the mobile robotic system further comprises one or more pressure sensors coupled to the extendable element and communicatively coupled to the processing system.

18. The system of claim 15, wherein the mobile robotic system further comprises a motion controller, the motion controller communicatively coupled to one or more of the processing system, the extendable element, and the wheeled platform.

19. The system of claim 15, further comprising an alerting system, wherein the alerting system alerts personnel if a vibration measurement is not within a predetermined range.
